(19) United States
(12) Patent Application Publication
(10) Pub. No.: US 2012/0330862 A1
(43) Pub. Date: Dec. 27, 2012

(54) Single-Stock Futures Contract (SSFC)

(76) Inventors: Chris Ryan, Houston, TX (US); William Breck, Sparks, NV (US)

(21) Appl. No.: 12/985,330

(22) Filed: Jan. 5, 2011

Related U.S. Application Data
(60) Provisional application No. 61/292,416, filed on Jan. 5, 2010.

(51) Int. Cl. G06Q 40/06

(52) U.S. Cl. 705/36 T

(57) ABSTRACT

The “invention” described in this Application is a method, process, structure, system and formulation describing one way how to produce a “financial instrument” which can simultaneously: (1) permit an organization qualified to receive “tax deductible” donations under IRC §170(c)(2) and §2055(a)(2) to issue a “securities futures contract” (the “SSFC”) without violating the restrictions on transfer of restricted stock under SEC Rule 144; and (2) qualify the SSFC as an “exempt security” (not subject to registration or regulation under the Federal Securities Acts or the Commodities Trading Acts of the U.S. Government, when issued by a qualified “tax exempt organization” described in IRC §170(c)(2) and §501(c)(3)-); and (3) qualify the SSFC as a “securities futures contract” within the meaning of the definition in IRC §1234B; and (4) permit the “tacking” of the holding period (under IRC §1223(14)-) of the SSFC onto the holding period of the securities delivered pursuant to the SSFC (provided the SSFC not a §1256 contract); and (5) qualify the purchaser and/or holder of the SSFC, who remains as the holder of the securities delivered pursuant to the SSFC, to receive a charitable income tax deduction under IRC §170(a), or a charitable estate tax deduction under IRC §2055(a), equal to the ‘current market value’ of the donated securities (when the donated securities were received pursuant to the “securities futures contract” and held as a ‘capital asset’ by the holder for a combined holding period which is longer than one (1) year); without regard to the (possibly lesser) “cost basis” of the donor in the securities acquired pursuant to the SSFC; and, without regard to the (possibly shorter) holding period of the donated securities, if/when computed only from the date that the donated securities were delivered pursuant to the SSFC to the donor of the securities.

### CROSS-REFERENCE TO RELATED APPLICATIONS

This Application claims priority by reference to the Provisional Patent Application filed on Jan. 5, 2010, under application No. 61/292,416.

The “invention” described in this Application is a method, process, structure, system and formulation describing one way how to produce a “financial instrument” which can simultaneously: (1) permit an organization qualified to receive “tax deductible” donations under IRC §170(c)(2) and §2055(a)(2) to issue a “securities futures contract” (the “SSFC”) without violating the restrictions on transfer of restricted stock under SEC Rule 144; and (2) qualify the SSFC as an “exempt security” (not subject to registration or regulation under the Federal Securities Acts or the Commodities Trading Acts of the U.S. Government, when issued by a qualified “tax exempt organization” described in IRC §170(c)(2) and §501(c)(3)-); and (3) qualify the SSFC as a “securities futures contract” within the meaning of the definition in IRC §1234B; and (4) permit the “tacking” of the holding period (under IRC §1223(14)-) of the SSFC onto the holding period of the securities delivered pursuant to the SSFC (provided the SSFC not a §1256 contract); and (5) qualify the purchaser and/or holder of the SSFC, who remains as the holder of the securities delivered pursuant to the SSFC, to receive a charitable income tax deduction under IRC §170(a), or a charitable estate tax deduction under IRC §2055(a), equal to the ‘current market value’ of the donated securities (when the donated securities were received pursuant to the “securities futures contract” and held as a ‘capital asset’ by the holder for a combined holding period which is longer than one (1) year); without regard to the (possibly lesser) “cost basis” of the donor in the securities acquired pursuant to the SSFC; and, without regard to the (possibly shorter) holding period of the donated securities, if/when computed only from the date that the donated securities were delivered pursuant to the SSFC to the donor of the securities.

The “Single-Stock Securities Futures Contract” attached hereto and submitted herewith represents one expression of the application of the methods, processes, structure, system and formulation described in this Application, to produce a document which meets the conditions and limitations of the applicable tax and securities laws described herein.

The inventors submitting this Application specifically do not claim that the method, process, structure, system or formulation (or the instrument produced thereby), as described in this Application, describes the only way that an instrument may be created, structured or formulated to comply with the various tax and securities laws referred to in this Application, or that the instrument attached to this application (frequently referred to herein as the “Single-Stock Futures Contract” (or “SSFC”)-) is the only form of instrument that can satisfy all of the conditions and limitations of the applicable tax laws and/or securities laws.

The form of instrument attached hereto, entitled “Single-Stock Securities Futures Contract” (the “Example”), and referred to herein alternatively as “Single-Stock Securities Futures Contract”, “Single-Stock Futures Contract”, “Securities Futures Contract”, “Futures Contract”, or “SSFC”, represents only one possible expression or formulation of an instrument meeting the conditions and limitations described in this Application, and as such is merely an Example, which Example is claimed to be fully subject to the protections of the U.S. Copyright Laws and International Treaties protecting works of creation and imagination within the respective protections of such laws and treaties.

Except to the limited extent that such Example is reproduced as an integral part of this Patent Application (for the purpose of illustrating the application of the methods, processes, structures, systems, and formulations described in this Patent Application), the author(s) of the instrument attached hereto as the Example reserve all rights under the applicable Copyright Laws and Treaties in and to the reproduction, use and publication of such Example, and all derivative works based thereon or inspired thereby.

### GOVERNMENT INTERESTS

A portion of the disclosures in this Patent Application contain or refer to material which is subject to protection under the Copyright Laws of the United States of America, and various International Treaties. The Copyright owner has no objection to the facsimile reproduction by anyone of the patent document, or the patent disclosure, as it appears in the Patent and Trademark. Office patent file or records, but otherwise reserves all Copyright rights whatsoever.

### REFERENCE TO COMPUTER PROGRAM LISTING COMPACT DISC APPENDIX

No Computer Program or Compact Disc is attached to this Application.

However, the applicants have attached hereto a document entitled “Single-Stock Securities Futures Contract” (the “Example”), which is referred to herein alternatively as “Single-Stock Securities Futures Contract”, “Single-Stock Futures Contract”, “Securities Futures Contract”, “Futures Contract”, or “SSFC”. The said “Single-Stock Securities Futures Contract” (the “Example”) represents only one possible expression or formulation of an instrument meeting the conditions and limitations described in this Application, and as such is merely an Example, which Example is claimed to be fully subject to the protections of the U.S. Copyright Laws and International Treaties protecting works of creation and imagination within the respective protections of such laws and treaties.

Except to the limited extent that such Example is reproduced as an integral part of this Patent Application (for the purpose of illustrating the application of the methods, processes, structures, systems, and formulations described in this patent application), the author(s) of the instrument attached hereto as the Example reserve all rights under the applicable Copyright Laws and Treaties in and to the reproduction, use and publication of such Example, and all derivative works based thereon or inspired thereby.

### BACKGROUND OF THE INVENTION

1. Field of the Invention

Commodities have been traded and hedging of prices of farm commodities for future delivery has existed since biblical times, and securities have been issued and traded since before the founding of the United States of America. However, the use of a “futures contract” to contract for the future delivery of an individual security or groups of securities (e.g., stocks and other securities of for-profit corporations) is relatively new, and was formalized in the United States of America by the Commodity Futures Modernization Act of 2000, “enacted as Pub. L. 106-554, Sec. 1(a)(7) [title IV, Sec. 401(a)], Dec. 21, 2000, 114 Stat. 2763, 2763A-648; {and} amended {by} Pub. L. 107-147, title IV, Sec. 412(d)(1)(B), (3)(B), Mar. 9, 2002, 116 Stat. 53, 54; Pub. L. 108-311, title IV, Sec. 405(a)(1), Oct. 4, 2004, 118 Stat. 1188” according to the Legislative History Note to 26 USC §1234B.

As subsequently amended in 2002 and 2004, the Commodity Futures Modernization Act of 2000 divided the jurisdiction over futures contracts between the U.S. Commodities Futures Trading Commission (the “CFTC”) and the U.S. Securities Exchange Commission (the “SEC”), and assigned the regulatory jurisdiction over “securities futures contracts” to the SEC, while allocating the regulatory jurisdiction over “index futures” and “commodities” to the CFTC.

The type of financial futures derivative contract described in this Application is a “Single-Stock Futures Contract” (SSFC), which may arguably fall within the jurisdictional area allocated to the SEC. However, the SEC has only issued one known pronouncement relating to such a Futures Contract, by SEC Release No. 33-8091, effective Jun. 7, 2002, which amended their regulations to include a “securities futures contract” within the definition of a “security” as defined under the Securities Act of 1933 and the Securities Exchange Act of 1934, to conform with the mandate of the Commodities Futures Modernization Act of 2000.—See the discussion under Legal Background infra at [000].

Prior to the creation of the “Single-Stock Futures Contracts” (SSFC), in the form described in this Application, there are no known SSFC contracts that have ever been created or issued, and no known exchanges which permit the trading of Single-Stock Futures Contracts.

2. Description of Prior Art

Prior to the creation of the SSFC, as described in this Application, “futures contracts” have been used as mechanisms to hedge or to speculate on the future prices of commodities (e.g., corn, oil, pork-bellies, and other agricultural commodities) and securities indexes (e.g., the CBOE Volatility index (VIX); the S & P 500 index (aka “SPX”); etc.). However, there is no known instance in which a person has issued or traded a “single-stock futures contract”, similar to the SSFC described in this Application, or in which a “single-stock futures contract”, similar to the SSFC described in this Application, has ever been listed for trading on any securities or commodities exchange.

Prior to the creation of the SSFC, as described in this Application, there are no known instances in which a non-profit charitable organization has utilized a “single-stock futures contract” to solicit a prospective purchaser of or to sell a “non-exempt security”, either prior to or after the date that the “non-exempt security” was registered with the SEC or listed for trading on any securities exchange.

Prior to the creation of the SSFC, as described in this Application, the only extant “securities futures contracts” were traded on established securities or commodities exchanges and were tied to specific publically traded stocks or indexes, such as the S & P 500 securities index. Such exchange traded “securities futures contracts” were required to be “marked to market” daily, and were subject to the same margin rules as applied to stocks traded in a margin account by persons buying and selling stocks of publically traded companies on established securities exchanges.

The only exchange which is know to currently trade some version of a single-stock futures contract is the One Chicago Exchange (http://www.onechicago.com/).

Although the literature currently available (see: http://www.mysmp.com/futures/futures-contract.html; http://www.investorwords.com/2134/futures.html; http://www.answers.com/topic/futures-contract; http//www.businessdictionary.com/definition/futures-contract.html; http://financial-dictionary.thefreeedictionary.com/Security+future) describes a “securities futures contract” as an “exchange traded futures contract”, as distinguished from a “forward contract” which is said to be ‘not exchange traded’, there is no known legal definition of a “securities futures contract” or “forward contract” which describes such distinction as a necessary or essential characteristic of a “securities futures contract” as distinguished from a “forward contract”. It is merely a distinction used as a matter of convenience, to distinguish between contracts which are “exchange traded” (referred to as “futures contracts”) and contracts which are “not exchange traded” (referred to as “forward contracts”), which are traded “over the counter” (i.e., in a private market).

The risks of trading these traditional exchange traded securities futures contracts are described in a document entitled: Risk Disclosure Statement for Security Futures Contracts; which is available at link: http://www.unitedfutures.com/single-stock-futures/stock_futures_disclosure.pdf

3. Legal Background

The U.S. Securities and Exchange Commission, effective Jun. 7, 2002, by Release No. 33-8091 (available at: http://www.sec.gov/rules/final/33-8091.htm#P37_{—}3471), amended their regulations to include a “securities futures contract” within the definition of a “security” as defined under the Securities Act of 1933 and the Securities Exchange Act of 1934, to conform with the mandate of the Commodities Futures Modernization Act of 2000:
“One of the purposes of the Commodity Futures Modernization Act of 2000 is to provide a regulatory framework for the trading of futures contracts on equity securities. The CFMA permits national securities exchanges registered under Section 6 of the Exchange Act and national securities associations registered under Section 15A(a) of the Exchange Act to list futures on individual securities and on narrow-based security indices (“security futures”). Among other things, the CFMA:
   Amended the definition of “security” in Section 2(a)(1) of the Securities Act and Section 3(a)(10) of the Exchange Act to include security futures;
   Amended the definition of “equity security” in Section 3(a)(11) of the Exchange Act to include security futures;
   Exempted certain security futures from the registration requirements of the Securities Act;
   Exempted security futures from the provisions of Section 12(a) of the Exchange Act;
   Amended Section 12(g) of the Exchange Act to clarify that security futures arc not equity securities of the issuer of the underlying securities; and
   Amended Section 16 of the Exchange Act to cover ownership of and transactions in, security futures.
“No futures contracts on single stocks or on narrow-based security indices are currently traded on national securities exchanges or associations.
“We are amending the definitions of “equity security” in Securities Act Rule 405 and Exchange Act Rule 3a11-1 to include security futures, consistent with the statutory treatment of security futures. We adopted Rule 3a11-1 in 1965 to clarify that the term “equity security,” as used in Sections 12(g) and 16 of the Exchange Act as well as Exchange Act Rule 12h-1, includes a wider range of equity interests than are specifically listed in the Exchange Act definition. In 1982, in connection with our adoption of the integrated disclosure system, we amended the definition of “equity security” in Rule 405 to conform it to the definition in Rule 3a11-1. The Rule 405 revision was made on the ground that there was no basis for defining “equity security” differently for purposes of our Securities Act rules than for our Exchange Act rules. We are amending the definitions of “equity security” in Rules 405 and 3a11-1 in the same fashion. Both rules would therefore remain identical.
“Because certain security futures are statutorily exempt from registration under the Securities Act and the Exchange Act, and are expressly included in Section 16 of the Exchange Act, we do not believe that the conforming changes will have any substantive impact. Rather, we believe that the changes will prevent any ambiguity from arising as a result of differences between the statutes and rules.
“As amended, the definition of “equity security” in both Securities Act Rule 405 and Exchange Act Rule 3a11-1 will read as follows (new language underscored):
“‘[a]ny stock or similar security, certificate of interest or participation in any profit sharing agreement, preorganization certificate or subscription, transferable share, voting trust certificate or certificate of deposit for an equity security, limited partnership interest, interest in a joint venture, or certificate of interest in a business trust; any security future on any such security: or any security convertible, with or without consideration into such a security, or carrying any warrant or right to subscribe to or purchase such a security; or any such warrant or right; or any put, call, straddle, or other option or privilege of buying such a security from or selling such a security to another without being bound to do so.’”—(underlining in original)—SECURITIES AND EXCHANGE COMMISSION—AMENDMENT TO DEFINITION OF “EQUITY SECURITY”—17 CFR Parts 230 and 240 [Release Nos. 33-8091; 34-45769; File No. S7-11-02] RIN: 3235-A140—effective Jun. 7, 2002.

The U.S. Internal Revenue Code (the “IRC” compiled in title 26 of the United States Code, the “USC”) defines a “security futures contract” in MC §1223(14) and §1234B, as follows:
IRC §1223(14) refers to a “securities futures contract” as:
“(14) If the security to which a securities futures contract (as defined in §1234B) relates (other than a contract to which §1256 applies) is acquired in satisfaction of such contract, in determining the period for which the taxpayer has held such security, there shall be included the period for which the taxpayer held such contract if such contract was a capital asset in the hands of the taxpayer.”—(underlining added)
And, IRC §1234B defines a “securities futures contract” as:
“(c) Securities futures contract—For purposes of this section, the term ‘securities futures contract’ means any security future (as defined in §3(a)(55)(A) of the Securities Exchange Act of 1934, as in effect on the date of the enactment of this section). The Secretary may prescribe regulations regarding the status of contracts the values of which are determined directly or indirectly by reference to any index which becomes (or ceases to be) a narrow-based security index (as defined for purposes of §1256(g)(6)).”—(underlining added)

The SSFC, as described in this Application, is not “a contract to which IRC §1256 applies” (within the meaning of IRC §1223(14)-), because the last sentence of IRC §1256(b) limits the definition of a “§1256 contract” so as to “not include any securities futures contract . . . unless such contract . . . is a dealer securities futures contract.” And, the term “dealer securities futures contract” is limited by IRC §1256(g)(9)(A) to contracts which are “entered into” or “purchased or granted” “by [a] dealer . . . in the normal course of [the dealer's] activity of dealing in such contracts” which are “traded on a qualified board or exchange”, and by IRC §1256(g)(9)(B) to a “person [who] performs . . . functions similar to the functions performed by [options dealers] described in paragraph (8)(A).” Further, the “options dealer” described in IRC §1256 (g)(8)(A) is clearly limited to a “person registered with [a] national securities exchange as a market maker or specialist”, who has the obligation to make a market in one or more designated securities on a regular and continuous basis, under the provisions of the Securities Exchange Act of 1934, compiled in 15 USC §78c at 15 USC §78c (a)(38).

Therefore, the SSFC as described in this Application is not excluded from IRC §1223(14) by the language excluding “a contract to which §1256 applies”.

The language in IRC §1234B, defining a “securities futures contract” by explicit reference to §3(a)(55)(A) of the Securities Exchange Act of 1934, was enacted on the same date as IRC §1234B. And, §3(a)(55)(A) of the Securities Exchange Act of 1934 (the “Exchange Act”) defines a “security future” as:
“The term ‘security future’ means a contract of sale for future delivery of a single security or of a narrow-based security index, including any interest therein or based on the value thereof, [1^{st}] except an exempted security under §3(a)(12) of the Securities Exchange Act of 1934 as in effect on the date of the enactment of the Futures Trading Act of 1982 (other than any municipal security as defined in §3(a)(29) as in effect on the date of the enactment of the Futures Trading Act of 1982). The term ‘security future’ does not include any agreement, contract, or transaction [2^{nd}] excluded from the Commodity Exchange Act under section 2(c), 2(d), 2(f), or 2(g) of the Commodity Exchange Act (as in effect on the date of the enactment of the Commodity Futures Modernization Act of 2000) or [3^{rd}] title IV of the Commodity Futures Modernization Act of 2000.” (emphasis, [1^{st}], [2^{nd}] & [3^{rd}] and underlining added)

Note that §3(a)(55)(A) of the Securities Exchange Act of 1934 was enacted on the same date as IRC §1234B (i.e., the “References in Text” note to IRC §1234B states that: “The date of the enactment of this section, referred to in subsec. (c), is the date of enactment of Pub. L. 106-554, which was approved Dec. 21, 2000.”). The ‘Futures Trading Act of 1982’ (Pub. L. 97-444) was enacted on Jan. 11, 1983.

Therefore, in order to determine whether the SSFC, as described in this Application, is a “securities futures contract” it must be determined that the SSFC is not within any of the three (3) exception/exclusion clauses, i.e., (“[1^{st}]”), (“[2^{nd}]”) and (“[3^{rd}]”) underlined above in the quote from §3(a)(55)(A) of the Securities Exchange Act of 1934.

The ‘exception’ in clause [1] (i.e., for “an exempted security under §3(a)(12) of the Exchange Act of 1934”) applies only if the SSFC issued by the IRC §501(c)(3) organization fits within any of the following four (4) categories listed in §3(a)(12) of the Exchange Act, since none of the other categories listed in §3(a)(12) appear to be even arguably applicable:
(1) an “interest or participation in any common trust fund or similar fund that is excluded from the definition of the term ‘investment company’ under §3(c)(3) of the Investment Company Act of 1940” under §3(a)(12)(A)(iii) of the Exchange Act; or
(2) an “interest or participation in any pooled income fund, collective trust fund, collective investment fund, or similar fund that is excluded from the definition of an investment company under §3(c)(10)(B) of the Investment Company Act of 1940” under §3(a)(12)(A)(v) of the Exchange Act; or
(3) “any security issued by or any interest or participation in any church plan, company, or account that is excluded from the definition of an investment company under §3(c)(14) of the investment Company Act of 1940” under §3(a)(12)(A)(vi) of the Exchange Act; or
(4) “such other securities (which may include, among others, unregistered securities, the market in which is predominantly intrastate) as the Commission may, by such rules and regulations as it deems consistent with the public interest and the protection of investors, either unconditionally or upon specified terms and conditions or for stated periods, exempt from the operation of any one or more provisions of this title” under §3(a)(12)(A)(vii) of the Exchange Act.

§3(c)(14) of the Investment Company Act of 1940 (complied at 15 USC 80a-3 (c)(14)) is clearly limited to:
“(14) Any church plan described in section 414(e) of title 26”. And, 26 USC §414 (e)(1) clearly defines the term “church plan” as: “a plan established and maintained . . . by a church or by a convention or association of churches which is exempt from tax under section 501.”

Therefore, to avoid the application of the provisions quoted in (1) thru (3) above, all that is necessary is that the IRC §501(c)(3) organization does not issue the SSFC in connection with a “common trust fund” or “collective trust fund”, a “pooled income fund” or “similar fund”, or a “church plan”.

And, therefore, it may be assumed that an IRC §501(c)(3) organization that does not want to lose the benefits of the SSFC, as described in this Application, would simply not issue the SSFC in connection with a “common trust fund” or “collective trust fund”, a “pooled income fund” or “similar fund”, or a “church plan”.

Assuming that a §501(c)(3) organization which desires to use the SSFC to solicit purchasers who desire to purchase the securities described in the SSFC, would not elect misuse the SSFC in the fashion described in the four categories listed as exceptions from §3(a)(12) above, it is likely that the SSFC, as described in this Application, when issued by an IRC §501(c)(3) organization (not in connection with a “common trust fund” or “collective trust fund”, a “pooled income fund” or “similar fund”, or a “church plan”), would not fit within the exceptions in §3(a)(12)(A)(iii), (v), and (vi) of the Exchange Act, and would not be disqualified as a “security future” within the meaning of IRC §1223 (14) and IRC §1234B, by the first exclusion/exception in §3(a)(55)(A) of the Exchange Act, unless it falls within the scope of the regulatory exception in paragraph (4) above, under §3(a)(12)(A)(vii) of the Exchange Act, which refers to exemptions adopted by regulatory authority of the SEC in effect on the date of the enactment of the Futures Trading Act of 1982, P. L. 97-444, enacted Jan. 11, 1983, by virtue of the last pre-parenthetical clause in the first sentence of §3(a)(55)(A) of the Exchange Act.

The regulatory exemptions pertaining to “futures contracts” issued by the Securities and Exchange Commission are 17 CFR §240.3a55-1 (calculation of market capitalization for a ‘narrow-based futures contract’), §240.3a55-2 (‘narrow-based securities indexes’ underlying futures contracts traded for fewer than 30 days), §240.3a55-3 (futures contracts traded on a ‘foreign exchange’), and §240.3a55-4 (indexes based on ‘debt securities’). All of these provisions appear to have been enacted after the Jan. 11, 1983. But even if similar provisions were in effect on Jan. 11, 1983, when the Futures Trading Act of 1982 was enacted, none of these provisions appear to exempt from the definition in §3(a)(55)(A) of the Exchange Act, a “single-stock futures contract” such as the SSFC, as described in this Application.

Therefore, it is seems clear that the SSFC, as described in this Application, is not excluded from the definition of a “securities future” in §3(a)(55)(A) of the Exchange Act, by regulatory action of the Securities & Exchange Commission, under §3(a)(12)(A)(vii) of the Exchange Act, and would not be excluded from the definition of a “security future” by the language of the first (“[1^{st}]”) exclusion/exception in §3(a)(55)(A) of the Exchange Act, as long as it is issued by an IRC §501(c)(3) organization that is not an “eligible contract participant” (as defined in 7 USC §2(d)-), and does not fit within the exceptions in §3(a)(12)(A)(iii), (v), (vi) and (vii) of the Exchange Act, unless issued in connection with a “common trust fund” or “collective trust fund”, a “pooled income fund” or “similar fund”, or a “church plan”, within the meaning of the first (“[1^{st}]”) “exception” in §3(a)(55) of the Exchange Act.

The second (“[2^{nd}]”) exception/exclusion mentioned in §3(a)(55)(A) of the Exchange Act states that:
“The term ‘security future’ does not include any agreement, contract, or transaction excluded from the Commodity Exchange Act under section 2(c), 2(d), 2(f), or 2(g) of the Commodity Exchange Act (as in effect on the date of the enactment of the Commodity Futures Modernization Act of 2000) . . . ” (underlining added)

However, §2 (c) of the Commodity Exchange Act (as compiled at 7 USC §2 (c)) does not include a Single-Stock Futures Contract among the securities listed;

§2 (d) of the Commodity Exchange Act (as compiled at 7 USC §2 (d)) does not include a Single-Stock Futures Contract unless entered into between persons who are “only eligible contract participants”; (underlining added)

§2 (f) of the Commodity Exchange Act (as compiled at 7 USC §2 (f)), addresses “hybrid instruments” that are “predominantly a security”, and specifies as the second (§2 (f)(B)) of the four (4) mandatory characteristics that the “the purchaser or holder of the . . . instrument is not required to make any payment to the issuer in addition to the purchase price paid under subparagraph (A), whether as margin, settlement payment, or otherwise, during the life of the . . . instrument or at maturity”. However, this is not the case with the proposed SSFC, which contemplates first an “Initial Payment” at the initial issue of the SSFC and a second “Delivery Payment” due on or before the Delivery Date of the ‘single stock’ specified in the SSFC. Therefore, the SSFC, as described in this Application, is not within the exclusion specified in §2 (f) of the Commodity Exchange Act.

§2 (g) of the Commodity Exchange Act (as compiled at 7 USC §2 (g)), similar to §2 (d) discussed above, does not include a Single-Stock Futures Contract (SSFC) unless entered into between persons who are “only eligible contract participants”.

Therefore, the SSFC described in this Application, when issued by an IRC §501(c)(3) organization which is not an “eligible contract participant” (as defined in 7 USC §2 (d)-), is not within the second (“[2^{nd}]”)set of exclusions/exemptions mentioned in §3(a)(55)(A) of the Exchange Act, quoted above.

The third (“[3^{rd}]”) and final “exclusion” from the definition of a “security futures” contract in §3(a)(55)(A) of the Exchange Act applies to “any agreement, contract, or transaction excluded from . . . title IV of the Commodity Futures Modernization Act of 2000” (the “CFMA”, compiled at 7 USC §27-27f). (underlining added)

Title IV of the CFMA defines a “security future” for this purposes as a “contract of sale for future delivery of a single security or a narrow-based security index, including any interest therein or based on the value thereof.” This definition excludes futures on broad-based securities indices, which were previously permitted under the Commodities Exchange Act. Therefore, a “security future” that is a “contract of sale for future delivery of a single security” is not excluded from the definition of a “security futures” contract as defined in title IV of the CFMA.

However, title IV of the CFMA does specifically exclude from CFTC regulatory authority “identified banking product[s]” (defined at CFMA §402(b) and 7 USC §27 (a)(2)-) offered by a “Bank” (defined at CFMA §402 (a) and 7 USC §27 (a)-), which were “commonly offered on or before Dec. 5, 2000” (at CFMA §403 and 7 USC §27a), or which were “offered by Banks after Dec. 5, 2000” (at CFMA §404 and 7 USC §27b), and “other identified banking products” “if the product is a hybrid instrument that is predominantly a banking product under the predominance test set forth in subsection (b)” (at CFMA §405 and 7 USC §27c).

The second condition of the “predominance test” set forth at CFMA §405 (b) and 7 USC §27c (b) specifies (similar to the “predominance test” in §2 (f) of the Commodity Exchange Act) that:
“the purchaser or holder of the . . . instrument is not required to make any payment to the issuer in addition to the purchase price paid under subparagraph (A), whether as margin, settlement payment, or otherwise, during the life of the . . . instrument or at maturity”.
   However, the SSFC, in the form described in this Application, contemplates at least two payments (i.e., first, an “Initial Payment” at the original issue of the SSFC, and second, a “Delivery Payment” on or before the Delivery Date) prior to and as a condition of the Delivery of the ‘single stock’ specified in the SSFC.

Therefore, the SSFC, in the form described in this Application, is not within the (“[3^{rd}]” exclusion specified in Title IV of the CFMA §405, and 7 USC §27c, for “a hybrid instrument [that is] predominantly a banking product” under the “predominance test” in CFMA §405 (b) and 7 USC §27c (b).

And, for the reasons summarized above, the SSFC, in the form described in this Application, when issued by a “tax exempt organization” described in IRC §170(c)(2) and §501(c)(3) which is not an “eligible contract participant” (as defined in 7 USC §2 (d)-), and not a transaction that involves a “common trust fund” or “collective trust fund”, a “pooled income fund” or “similar fund”, or a “church plan” (as discussed above), is not within the [1^{st}], [2^{nd}] or [3^{rd}] “exceptions” or “exclusions” listed in §3(a)(55)(A) of the Exchange Act, and therefore qualifies as a “security future” contract within the meaning of §3(a)(55)(A) of the Exchange Act, and IRC §1234B.

4. Summary of Pertinent Cases and Rulings

There are no know cases or rulings which address or involve a Single-Stock Futures Contract (SSFC) as described in this Application. Pertinent regulations of the Internal Revenue Service (IRS), the Securities and Exchange Commission (SEC) and the Commodities Futures Trading Commission (CFTC), to the extent they exist, are discussed in the section entitled “Legal Background”, above.

### BRIEF SUMMARY OF THE INVENTION

A Method, Process, Structure, System and Formulation (and the “instrument” produced thereby) describing one way how to:
1. to structure and produce a financial instrument that qualifies as an “exempt security”, which is not subject to “registration” or regulation under the Securities Act of 1933, the Exchange Act of 1934, or the Investment Company Act of 1940 (the “Securities Acts”), or the supervisory jurisdiction of the U.S. Securities and Exchange Commission (the “SEC”) under current regulations issued pursuant to such Securities Acts;
2. to structure and produce a financial instrument that qualifies as an “exempt security”, which is not subject to “registration” or regulation under the Commodities Exchange Act (42 Stat. 998), the Futures Trading Act of 1982 (Pub. L. 97-444), or the Commodity Futures Modernization Act of 2000 (Pub. L. 106-544, enacted Dec. 21, 2000) (the “Commodities Trading Acts”), or the supervisory jurisdiction of the U.S. Commodities Futures Trading Commission (the “CFTC”) under current regulations issued pursuant to such Commodities Trading Acts;
3. to structure such “exempt security” to qualify as a “financial derivative” which may be issued by a “tax exempt organization” (such as described in Section (“§”) §170(c)(2) and §501(c)(3) of the U.S. Internal Revenue Code (the “IRC”), compiled in title 26 of the United States Code (the “USC”)-), without registration, regulation, or qualification as an “exempt transaction”, under the Securities Acts or the Commodities Trading Acts cited hereinabove;
4. to structure the “financial derivative” so that it qualifies as a “futures contract” within the meaning of MC §1234B, which incorporates the definition in §3(a)(55)(A) of the Securities Act of 1934;
5. to structure the “financial derivative” so that the sale of the “futures contract” is not treated as the sale of the underlying “non-exempt security” prior to the delivery of the underlying securities on the specified Future Delivery Date under SEC Rule 144;
6. to permit such “futures contract” to be utilized by a “tax exempt organization” to solicit purchasers for and to sell to such purchasers “non-exempt securities” of private corporations (and other entities), which are subject to ‘registration’ under the Securities Acts cited hereinabove, prior to the date that such “non-exempt securities” have been registered or otherwise qualified with the SEC under the said Securities Acts, with the delivery date deferred until after the effective date of such ‘registration’ of the “non-exempt securities” under said Securities Acts;
7. to obtain the “tacking” of the holding period of the “futures contract” with the holding period of the “non-exempt securities” of the private corporations (and other entities) delivered pursuant to the “futures contract”, referenced above, within the meaning of IRC §1223(14), to achieve a “long-term holding period” for the “non-exempt securities” prior to the date that the purchaser of the “non-exempt securities” would be able to achieve a “long-term holding period” for the “non-exempt securities”, in the absence of the integral presence of the “exempt security” structured as a “futures contract” in the transaction in which the purchaser acquires the “non-exempt securities”; and
8. to permit and/or to facilitate, by the use of the method, process, structure and system described herein, a “tax exempt organization” (as defined above) to accelerate the receipt of funding, in advance of the date on which such “tax exempt organization(s)” would otherwise be able to sell the “non-exempt securities” of private corporations (and other entities) acquired or held for investment, or received as donations, by such “tax exempt organizations”; and
9. to permit and/or facilitate, by the use of the method, process, structure and system described herein, a private corporation (or other entity) to make a “charitable donation” to a qualified “tax exempt organization”, by an “exempt transaction” prior to the date that the “non-exempt securities” of such private corporation (or other entity) have been registered or otherwise qualified with the SEC under the said Securities Acts; and
10. to limit or eliminate the risk of “non-delivery” of the specified stock or other securities to the purchaser of the “futures contract” by providing an escrowed reserve of a sufficient number of shares of the stock or other securities to be delivered to the purchaser of the “futures contract” prior to or contemporaneously with the issue of the “futures contract” by the issuer; and
11. to limit or eliminate the risk of “default” in the attainment of the pre-conditions to the delivery obligation specified in the “futures contract” by providing that a default in the satisfaction of the specified pre-conditions, gives rise to a right to receive a full refund of the purchase price paid by the “futures contract” purchaser; and
12. to limit or eliminate the risk of “default” in the payment of the full refund (specified in the preceding paragraph) by providing a surety or guarantee arrangement backed by a solvent and financially sound guarantor or surety.

To assist in the understanding of the manner in which the investors conceive that the various pre-conditions and limitations can be incorporated into a SSFC instrument, the inventors have attached an Example instrument which is entitled “Single-Stock Securities Futures Contract” (the “Example”).

The inventors submitting this Application specifically do not claim that the method, process, structure, system or formulation (or the instrument produced thereby), as described in this Application, describes the only way that an instrument may be created, structured or formulated to comply with the various tax and securities laws referred to in this Application, or that the Example instrument attached to this application (frequently referred to herein as the “Single-Stock Futures Contract” (or “SSFC”)-) is the only form of instrument that can satisfy all of the conditions and limitations of the applicable tax laws and/or securities laws.

The form of instrument attached hereto, entitled Single-Stock Securities Futures Contract (and referred to herein alternatively as “Single-Stock Securities Futures Contract”, “Single-Stock Futures Contract”, “Securities Futures Contract”, “Futures Contract”, or “SSFC”), represents only one possible formulation of an instrument meeting the conditions and limitations described in this Application, and as such is merely an Example, which Example is claimed to be fully subject to the protections of the U.S. Copyright Laws and International Treaties protecting works of creation and imagination within the respective protections of such laws and treaties. Except to the limited extent that such Example is reproduced as an integral part of this Patent Application (for the purpose of illustrating the application of the methods, processes, structures, systems, and formulations described in this Patent Application), the author(s) of the instrument attached hereto as the Example reserve all rights under the applicable copyright laws in and to the reproduction, use and publication of such Example, and all derivative works based thereon or inspired thereby

### DESCRIPTION OF THE DRAWINGS

FIG. 1 illustrates the issuance of the initial Series of Securities (SOS) by the For-Profit Company (FPC) to the Non-Profit Company (NPC) or 501(c)(3) organization.

FIG. 2 illustrates the commitment of the For-Profit Company (FPC) to issue the Second Series Of Securities (SSOS) to the Non-Profit Company (NPC) pursuant to the Soft Put Securities Purchase Agreement (SPSPA), subject to the satisfaction of the Identified Benchmarks of Performance (IBP).

FIG. 3 illustrates the sale of the Single Stock Futures Contract (SSFC) by the NPC to Investors (INV).

FIG. 4 illustrates the holding of the SSFC by the Investors until the Future Delivery Date (FDD), at which date it is anticipated that the Fair Market Value of the SOS (&/or SSOS) is likely to be higher than the Future Delivery Price (FDP).

FIG. 5 illustrates the application of SEC Rule 144, Securities Act section 12, and FINRA sections 15(c) and 211, and IRC sections 1223(14) and 1234B to the transaction.

### DETAILED DESCRIPTION OF THE INVENTION

To understand the invention, it is necessary to describe each of the many steps that must be taken to arrive at the desired form of financial instrument, as well as all of the structural attributes which must be created or involved to satisfy and implement the pre-conditions, limitations and obligations summarized in this Application:
1. First, there must exist (or be created) a “for-profit company” (the “FPC”) with an appropriate capital structure that will permit the FPC to satisfy all of the conditions and limitations imposed by the “qualified non-profit organization” and the applicable tax and securities laws, including specifically, but without limitation, the ability of the FPC to accomplish a full registration of its “common stock” (or similar class of securities) prior to the Deliver Date specified (or to be specified) in the “Single-Stock Futures Contract” (the “SSFC”).
2. Next, there must exist (or be found or created) a “non-profit organization” (the “NPO”) (qualified under IRC §170(c)(2) and §501(c)(3)-) which will receive a volume of stock (or other securities) from the FPC, pursuant to a purchase agreement or donation, place the volume of stock (or other securities) into an escrow account (with an “Escrow Holder”) restricted so that the stock (or other securities) will not be sold or otherwise become unavailable to satisfy the delivery obligations undertaken upon the issuance of one or more SSFC(s) by the NPO.
3. The Escrow Holder may be an independent person or entity which merely holds the stock (or other securities) until the Delivery Date specified in the SSFC(s) issued by the NPO; or the Escrow Holder may also act as the Surety (as described in the next paragraph) pursuant to a combined transaction.
4. A Surety arrangement must be established with a person or entity which undertakes to provide the solvency and financial capacity to ensure that the purchaser(s) of the SSFC(s) from the NPO receives a full refund of the amounts paid, if the preconditions to delivery of the stock (or other securities), including specifically but without limitation that the stock (or other securities) are included in an effective registration statement filed with the SEC under §12 of the Securities Exchange Act of 1934 prior to the Delivery Date specified in the SSFC(s).
5. The NPO may also desire to obtain a legal opinion providing assurances that the NPO may issue the SSFC in the form proposed, and receive funds from purchasers of the SSFC, without violating any state or federal laws, or engaging in any transaction(s) that may endanger the “tax exempt status” of the NPO.
6. The NPO may also require the consent of other persons (board of supervisors and/or affiliate or supported organizations) in order to be able to enter into the kinds of transactions contemplated by the issuance of the SSFC(s).
7. The NPO may also desire or be required to enter into other agreements with the FPC (or other entities) as a pre-condition of issuing the SSFC(s), such as stock purchase agreements permitting or requiring a future investment in the FPC, or consulting agreements to provide support services to assist the FPC to develop internal management skills and/or other skills, relationships or facilities which are necessary or desirable to assist the FPC to meet bench-marks or pre-conditions to attaining the status of a public company with an effective §12 registration statement prior to the Delivery Date specified in the SSFC(s) issued by the NPO.
8. The NPO may also desire or be required to enter into other arrangements with outside consultants (or other entities) as a pre-condition to participation in a program involving the issuance of SSFC(s), such as license agreements, charitable development agreements and other charitable management services or agreements which are provided as an adjunct to the installation and operation of a SSFC program for the particular NPO.
9. The NPO may also desire or be required to contract for certain additional services to be rendered to the purchasers of the SSFC(s), such as the provision of an ‘independent appraisal’ of the market value of the securities on the Delivery Date, or the subsequent date of the ‘donation’ of the securities to a organization qualified to receive ‘tax deductible donations’ under IRC §170(c)(2) and §2055(a)(2).
10. The NPO (after satisfying itself that the FPC can meet its obligations to file an effective registration statement under §12 of the Securities Exchange Act of 1934, and that the NPO is adequately protected against other eventualities) can then issue the SSFC(s) to its members, supporters and others who are interested in participating in the SSFC program of the NPO, in order to provide funding to the NPO, or to assist the NPO to support and develop entrepreneurship in the community through its program of education, support, instruction and financial incentives to the FPC, and other similarly situated individuals and entities.
11. Subject to certain conditions, limitations and exceptions (illustrated in the discussion herein, which is not intended as a complete listing of all disqualifying conditions, limitations and exceptions), the SSFC(s) issued by the NPO may qualify as “exempt securities” within the “exemptions” specified in §3(a)(4) of the Securities Act of 1933, §3(e) of the Securities Exchange Act of 1934, and §3(a)(10)(B) & (D) of the Investment Company Act of 1940, which may be issued by the NPO without ‘registration’ and without qualifying as an ‘exempt transaction’ under the Federal Securities Laws, and the ‘blue-sky’ laws of most states. (Note, however, that some states impose a notice or pre-filing requirement on non-profit organizations, and permit the state securities administrator to revoke or condition an exemption, when, in the judgment of the state securities administrator, such is required to protect the public interest.)
12. Subject to certain conditions, limitations and exceptions (illustrated in the discussion herein, which is not intended as a complete listing of all disqualifying conditions, limitations and exceptions), the SSFC(s) issued by the NPO may qualify as a “securities futures contract” within the meaning of the definitions in MC §1223(14) and §1234B, which permit the “tacking” of the holding period of the SSFC(s) with the holding period of the stock (or other securities) delivered pursuant to the SSFC, so that a holding period of 364 days (or any other holding period of 365 days or less) between the issue date of the SSFC and the Delivery Date of the stock (or other securities) delivered pursuant to the SSFC, plus a holding period of 2 days for the stock (or other securities) delivered pursuant to the SSFC (or any other holding period for the stock (or other securities) delivered pursuant to the SSFC which, when added to the holding period of the SSFC, is greater than 365 days), so that the combined total holding period (for the SSFC+stock delivered pursuant to the SSFC) is greater than 365 days, so that the holder is qualified to utilize the ‘market price’ of the stock (or other securities) as the basis for a ‘charitable income tax deduction’ for such number of shares of the stock (or other securities delivered pursuant to the SSFC) instead of (the possibly lesser) ‘cost basis’ of the donor in the stock (or other securities delivered pursuant to the SSFC) donated by the donor to a qualified charitable organization after the 365 day holding period has been met by the holder prior to the date of the donation of such stock (or other securities delivered pursuant to the SSFC) to a charitable organization qualified to receive tax deductible donations under IRC §170(c)(2).
13. Assuming that the purchaser of the SSFC is not an insider of the FPC, or holder of 10% or more of the issued and outstanding shares of the FPC (and that the transaction is not otherwise disqualified), the purchaser of the SSFC who receives the delivery of stock (or other securities) pursuant to the SSFC, may qualify to deduct a “charitable donation” of the stock (or other securities received pursuant to the SSFC), valued at the market price on the date of donation (and not at the ‘cost basis’ of the donor), in an amount up to 50% of the Adjusted Gross Income of the donor, if the contribution is to a publically supported charitable organization that is qualified to receive tax deductible donations under IRC §170(c)(2).
14. And, assuming that the pre-conditions, limitations and exceptions are complied with are satisfied, or are not applicable in the circumstances, the result of the method, process, structure, system and formulation described in this Application, when properly implemented as described herein, is that the volume of funding available to “tax deductible organizations” qualified to receive ‘tax deductible donations’ under IRC §170(c)(2), and §2055(a)(2), are facilitated and hopefully increased, due to the ease of making the contribution and the ready availability of the documentation to support the charitable contribution deductions taken pursuant to the program utilizing the SSFC.
15. And, assuming that more organizations qualified to receive ‘tax deductible donations’ under IRC §170(c)(2) and §2055(a)(2) are motivated to develop, adopt or improve programs to encourage and assist entrepreneurship and the development of small business enterprises in disadvantaged zones or among disadvantaged groups or persons, it is possible that more entrepreneurs will help the economy to create more jobs, to increase prosperity among the general population and disadvantaged groups, and to spread the American dream to more people in more places around the world.

### DRAWINGS

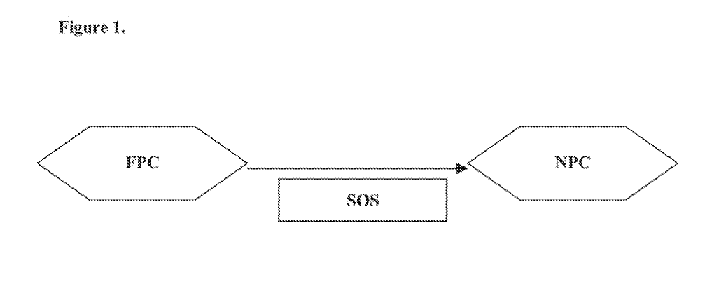

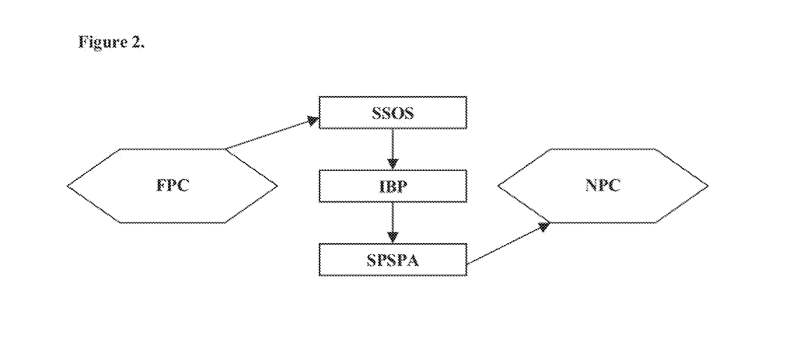

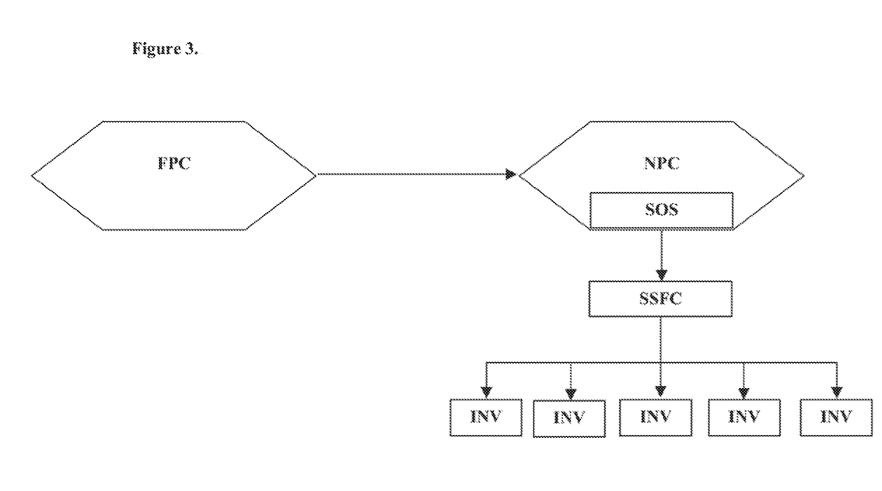

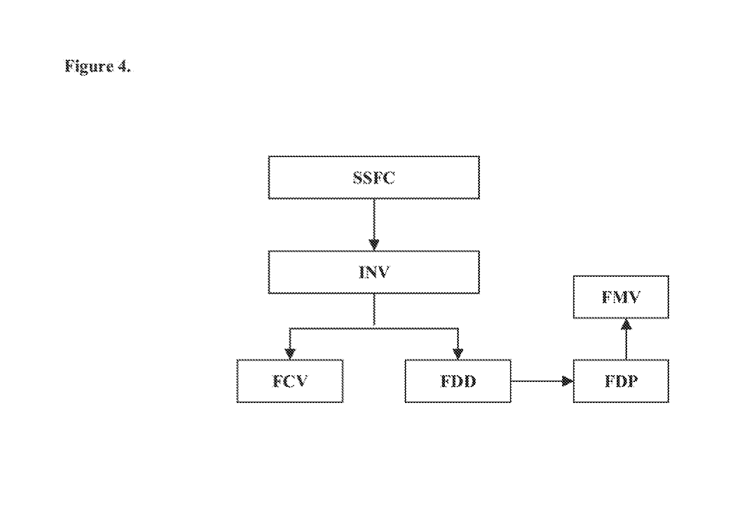

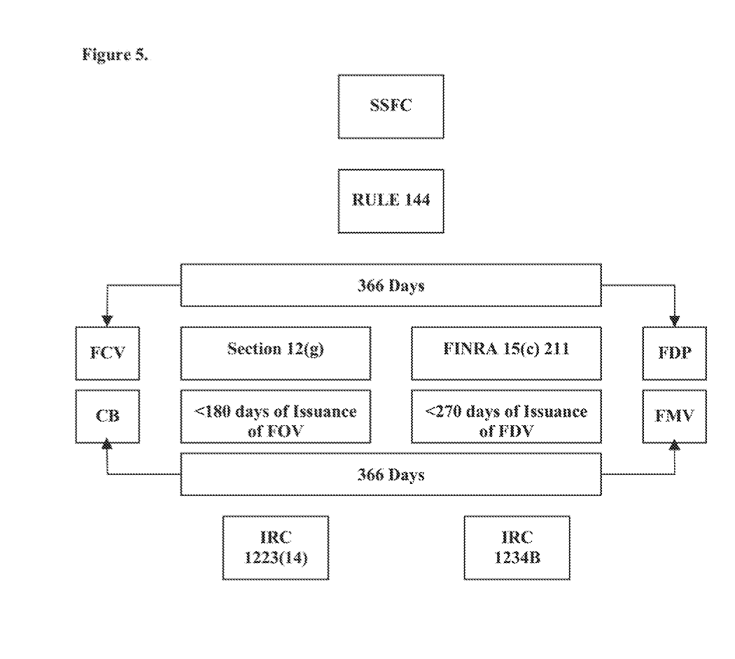

See FIGS. 1 through 5 attached.

ALSO SEE EXAMPLE OF A SINGLE STOCK FUTURES CONTRACT—ATTACHED HERETO AS EXHIBIT A—IMMEDIATELY FOLLOWING THE DIAGRAMS

The “Single-Stock Securities Futures Contract” attached hereto as EXHIBIT A, and submitted herewith, represents one expression of the application or the methods, processes, structure, system and formulation described in this Application, to produce a document which meets the conditions and limitations of the applicable tax and securities laws described herein.

The inventors submitting this Application specifically do not claim that the method, process, structure, system or formulation (or the instrument produced thereby), as described in this Application, describes the only way that an instrument may be created, structured or formulated to comply with the various tax and securities laws referred to in this Application, or that the instrument attached to this application (frequently referred to herein as the “Single-Stock Futures Contract” (or “SSFC”)-) is the only form of instrument that can satisfy all of the conditions and limitations of the applicable tax laws and/or securities laws.

The form of instrument attached hereto, entitled “Single-Stock Securities Futures Contract” (the “Example”), and referred to herein alternatively as “Single-Stock Securities Futures Contract”, “Single-Stock Futures Contract”, “Securities Futures Contract”, “Futures Contract”, or “SSFC”, represents only one possible expression or formulation of an instrument meeting the conditions and limitations described in this Application, and as such is merely an Example, which Example is claimed to be fully subject to the protections of the U.S. Copyright Laws and International Treaties protecting works of creation and imagination within the respective protections of such laws and treaties.

Except to the limited extent that such Example is reproduced as an integral part of this Patent Application (for the purpose of illustrating the application of the methods, processes, structures, systems, and formulations described in this Patent Application), the author(s) of the instrument attached hereto as the Example reserve all rights under the applicable Copyright Laws and Treaties in and to the reproduction, use and publication of such Example, and all derivative works based thereon or inspired thereby.

1. A method, process, structure, system and formulation:
1. to permit organizations which are qualified to receive ‘tax deductible donations’ under IRC §170(c)(2) and §2055(a)(2) (the “qualified organization(s)”), to raise funds by the issuance of “securities futures contracts” (i.e., in the form of a ‘single-stock securities futures contract’ (the “SSFC”) which provides for a minimum of 2 payments, with one payment at the initial issue of the SSFC and a second payment at the delivery date of the securities designated to be delivered pursuant to the SSFC) which provides for the delivery of securities held by the qualified organization at a future date, after the issuer of the securities has completed an effective registration statement with the SEC under §12 of the Securities Exchange Act of 1943; and simultaneously
2. to permit the issue of the SSFC(s) by such qualified organizations prior to the time that stock (or other securities) received as donations, or purchased for investment, in start-up or early stage ‘for-profit’ companies (i.e., before such companies have registered their securities with the U.S. Securities and Exchange Commission (SEC) under §12 of the Securities Exchange Act of 1934 and become “listed securities” on a registered securities exchange) may be sold without violating the restrictions on transfer of ‘restricted securities imposed by SEC Rule 144; and simultaneously
3. to qualify the SSFC issued by the qualified organization(s) as an “exempt security” (excluded from the SEC's registration requirements under §12 of the Securities Exchange Act, and the regulatory jurisdiction of the SEC by §3(a)(4) of the Securities Act of 1933, §3(e) of the Securities Exchange Act of 1934, and §3(a)(10)(B) & (D) of the Investment Company Act of 1940) which may be issued by the qualified organization without registration with the SEC and without registration with state securities administrators; (Note, however, that notwithstanding the uniform exemption from the registration requirements for securities issued by qualified non-profit organizations under federal and state securities laws, that some states do require the advance filing of a notice, and marketing information, and permit the state securities administrator to suspend the offering of non-profit organizations when such suspension is deemed to be in the public interest, in the judgment of the state securities administrator); and simultaneously
4. to permit the purchaser of a SSFC to limit risk of loss by minimizing the amount of funds at risk in the SSFC, until such time as the stock (or other securities to be delivered pursuant to the SSFC) has been listed for trading on a recognized ‘securities exchange’ pursuant to an effective registration statement with the SEC under §12 of the Securities Exchange Act of 1934; and simultaneously
5. to permit the purchaser of a SSFC to ‘tack’ the holding period of the SSFC {i.e., the period of time elapsing after the initial purchase or the SSFC by the purchaser/holder of the SSFC, prior to the delivery date specified in the SSFC for delivery of the stock (or other securities) pursuant to the SSFC} by adding the holding period of the SSFC {prior to the delivery of the stock (or other securities) specified in the SSFC} to the holding period for the stock (or other securities) delivered pursuant to the SSFC, to attain a “long-term capital gain” when the combined holding period (for the SSFC+the stock delivered pursuant to the SSFC) exceeds the 365 days required for “long-term capital gain” treatment, under IRC §1223(14), which permits the holder of the stock (or other securities) delivered pursuant to the SSFC to sell or donate such stock (or other securities) as a “capital asset” producing “long-term capital gain or loss” or a charitable donation deduction based on the “market value” of the stock (or other securities) on the date of the donation, instead of based on the “cost basis” of such stock (or other securities) received pursuant to the SSFC, when the combined holding period exceeds the 365 days required by 1RC §1223(14).
